(19) United States
(12) Patent Application Publication
(10) Pub. No.: US 2008/0036377 A1
(43) Pub. Date: Feb. 14, 2008

(54) Light Bulb Comprising An Illumination Body That Contains Carbide

(75) Inventors: Axel Bunk, Munchen (DE); Matthias Damm, Gaimersheim (DE); Georg Rosenbauer, Wassertrudingen (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCHE GLUHLAMPEN MBH, MUNCHEN (DE)

(21) Appl. No.: 11/631,812

(22) PCT Filed: Jul. 6, 2005
(86) PCT No.: PCT/DE05/01199

§ 371 Date: Jan. 8, 2007

(30) Foreign Application Priority Data
Jul. 19, 2004 (DE) 10 2004 034 787.5

(51) Int. Cl. H01K 13/00; H01J 61/30

(52) U.S. Cl. 313/578

(57) ABSTRACT

The invention relates to a light bulb (1) comprising an illumination body (7), which is inserted, together with a filler material, into a bulb (2) in a vacuum-tight manner. The illumination body (7) has a metal carbide, whose melting point lies above that of tungsten. The current supply (10) is configured in two parts from a first section (6) and a second section (15). The first section is configured integrally with the illumination body (7) and consists of a wire and the second section, which functions as the actual current supply (15) is produced from a highly heat-resistant material.

### TECHNICAL FIELD

The invention is based on an incandescent lamp having a carbide-containing luminous body in accordance with the precharacterizing clause of claim 1. The lamps in question here are in particular halogen incandescent lamps which have a luminous body consisting of TaC or whose luminous body contains TaC as a constituent part or coating.

### PRIOR ART

An incandescent lamp having a carbide-containing luminous body is known from many documents. A problem which has yet to be solved is the severely restricted life. One possibility described in WO 01/15206 consists in connecting the luminous body to a separate frame for holding purposes.

Tantalum carbide has a melting point which is approximately 500 K higher than tungsten. The temperature of a luminous body consisting of tantalum carbide can therefore be set to be considerably higher than that of a luminous body consisting of tungsten. Owing to the higher temperature of the luminous body and the increased emission of the tantalum carbide in the visible spectral range, considerably higher luminous efficiencies can be realized with tantalum carbide lamps (=lamps with tantalum carbide as the luminous body) than with lamps having conventional incandescent bodies consisting of tungsten. Until now, it has predominantly been the brittleness of the tantalum carbide and the rapid decarburization or decomposition of the luminous body at high temperatures which have stood in the way of marketing tantalum carbide lamps. In order to overcome the problem of the brittleness, patent literature has proposed, for example, the use of optimized carburization processes (DE 1.558.712, U.S. Pat. No. 3,650,850), the use of alloys of TaC with other carbides/materials (for example TaC+WC, TaC+HfC, etc., see U.S. Pat. No. 3,405,328, U.S. Pat. No. 4,032,809), and the use of support materials (U.S. Pat. No. 1,854,970).

In order to keep the complexity in terms of manufacturing as low as possible when constructing a TaC lamp, it is proposed to construct a TaC lamp having the same geometry as a conventional low-volt halogen lamp using quartz technology, see FIG. 3, for example.

FIG. 3 shows an incandescent lamp 1 having a pinch seal at one end and having a bulb consisting of hard glass 2, a pinch seal 3, and inner power supply lines 6, which are connected to a luminous body 7 in the pinch seal 3 via foils 4. The foils 4 are connected to outer feed lines 5.

For this purpose, first filaments are manufactured from tantalum wire, and these filaments are used to construct rod-shaped lamps. Then, the luminous body consisting of tantalum wire in the rod-shaped lamp is carburized using a mixture of methane and hydrogen. As regards the basic properties for carburization, cf. for example, S. Okoli, R. Haubner, B. Lux, Surface and Coatings Technology 47 (1991), 585-599, and G. Hörz, Metall [Metal] 27, (1973), 680. In this context, two properties of the carburization reactions are relevant:

(1) During carburization, initially the brittle subcarbide Ta₂C is formed. Given a further supply of carbon, the TaC phase then forms.

(2) The carburization reaction takes place more rapidly the higher the temperature.

The simplest possibility for bringing the luminous body to the temperatures required for carburization consists in applying a suitable voltage to the luminous body. However, owing to thermal dissipation, a temperature drop occurs in the process from the ends of the luminous body towards the pinch seal. In any case sufficiently high temperatures can be set at the luminous body such that continuous carburization takes place. Directly above the pinch seal, the temperatures are so low (usually below 700° C.), however, that no carburization takes place at all. In this region, temperatures required for complete carburization can only be set with great difficulty. Located between the region directly at the pinch seal, in which a wire consisting of tantalum is still present, and the completely carburized luminous body there is a region in which the brittle subcarbide Ta₂C is present. When subjected to an impact, the luminous body preferably breaks precisely in this region. The object is now to protect or stabilize this region as much as possible such that the susceptibility to breakage in this region is reduced. This stabilization should at least make safe transport of the lamp to the customer possible.

One possibility consists in protecting the critical region in which the brittle subcarbide Ta₂C dominates by the use of a covering coil, as is described in DE-Az 10 2004 014 211.4 (not yet published).

An obvious strategy for avoiding the described problems consists in fixing the tantalum filament in the lamp bulb by means of a frame. For example, a filament consisting of tantalum wire can be welded to solid frame parts, for example ones consisting of molybdenum, and then the tantalum filament carburized to form tantalum carbide. Owing to the severe dissipation of heat through the molybdenum power supply lines, which have a much larger diameter than the tantalum wire, however, a severe temperature gradient occurs along the tantalum filament towards the weld point. This results in the tantalum wire not being fully carburized close to the weld point and results in a region in which the particularly brittle tantalum subcarbide Ta₂C dominates. When subjected to an impact, the luminous body preferably breaks in this region. In order to solve this problem, additional complexity is involved. For example, the ends of the luminous body, which, prior to the carburization, consists, for example, of Ta, Hf, Nb, Zr or alloys of these metals, can be protected from the carburization by a coating.

### DESCRIPTION OF THE INVENTION

One object of the present invention is to provide an incandescent lamp having a carbide-containing luminous body, in particular with a halogen filling, in accordance with the precharacterizing clause of claim 1 which makes a long life possible and overcomes the problem of the breakability of the luminous body.

These objects are achieved by the characterizing features of claim 1. Particularly advantageous refinements can be gleaned from the dependent claims.

According to the invention, an integral luminous body is used for this purpose, in which the two power supply lines are a continuation of the wound luminous body. The luminous body and the power supply line are formed from a single wire.

The invention is based on the concept of avoiding the formation of the brittle subcarbide Ta₂C completely by virtue of the fact that, during the carburization, the tantalum wire is not located at any point in such a temperature range in which the carburization remains at the stage of the subcarbide. For this purpose, the outgoing lines of the filament consisting of tantalum wire are formed from another material in the “lower”, “colder” part towards the pinch seal. The filament consisting of tantalum wire is welded to a wire consisting of another material, which has a sufficiently small diameter of the order of magnitude of the diameter of the tantalum wire, with the result that increased heat dissipation through the outgoing line is avoided as when a frame is used. The material of the wire from which the outgoing filament line is formed should not form any carbides at the temperatures occurring there since carbides generally have an increased susceptibility to breakage and, secondly, the make-proofness is considerably reduced by the increased electrical resistance. The outgoing lines therefore need to be produced from a relatively thin wire consisting of a material which has a high melting point, is sufficiently hard, has an electrical conductivity and thermal conductivity which is comparable to that of tantalum and should not react with the carbon transported there from the gas phase. Examples of such materials are the metals rhenium, osmium and possibly also ruthenium and iridium. These metals have high melting points (rhenium: 3453 K, osmium: 3318 K, ruthenium: 2583 K, iridium: 2683 K). They form alloys with tantalum, which makes it possible for a welded joint to be formed between the tantalum wire and the wires consisting of rhenium or osmium or iridium or ruthenium. The joint between the two metals should be at a temperature at which the tantalum wire is completely carburized. The lower limit temperature up to which a tantalum wire is completely carburized depends on the wire diameter and the respective boundary conditions during carburization (methane concentration, time required for carburization, etc.). Typically, this lower limit temperature is in the range of between 2200 K and 3000 K. Since the joint between the two metals represents a singularity, it should, however, not be subjected to a higher thermal load during lamp operation than is absolutely necessary; it should if possible be below 3000 K; in any case, it should be at a markedly lower temperature in comparison with the filament, however. The condensation of the metal deposited by the outgoing lines on the bulb wall can easily be prevented by suitable halogen cycle processes.

The invention described here relates in particular to lamps having a reduced bulb volume, the distance between the luminous body, in particular its luminous sections, from the inner wall of the bulb being at most 18 mm. In particular, the bulb diameter is at most 35 mm, in particular in the range of between 5 mm and 25 mm, preferably in the range of between 8 mm and 15 mm. Given a bulb with such small dimensions, in particular such a small diameter, the risk of deposition of solids on the bulb wall necessarily needs to be counteracted. Given such small bulb diameters, depending on the color temperature of the filament, blackening of the bulb can be markedly reduced or avoided by means of a two-cycle process, as is described in DE-Az 103 56 651.1 (as yet unpublished).

The luminous body is in particular one which is arranged axially or transversely with respect to the axis in a bulb which is sealed, in particular pinch-sealed, at one or two ends.

The luminous body is preferably a singly wound wire, whose ends, which are used as an attachment for the power supply line, are not wound. Typical diameters of the wire for the luminous body are from 50 to 300 μm. The luminous body is typically formed from 5 to 20 turns. A preferred pitch factor for achieving stability of the luminous body which is as high as possible is 1.4 to 2.8.

Particularly preferably, the actual power supply line extends onto the region which enters into the bulb material from the bulb interior. The bulb is normally closed off by one or two pinch seals. The region of the transition is referred to as a pinch-seal edge.

Particularly preferably, the actual power supply line, which is formed from a material which does not form any carbides, extends over at least 50%, preferably over at least 80% of the length of the power supply line, depending on the temperature profile at the power supply line.

The luminous body is preferably axial since the concept of the axial luminous body is in principle well suited for applying an efficiency-increasing covering to the bulb. A so-called infrared coating (IRC), as is described, for example, in U.S. Pat. No. 5,548,182, is known. Correspondingly, the bulb can also be adapted specially for this, for example be provided with an elliptical or cylindrical shape, as is known per se.

One particular advantage consists in the use of halogen fillings, since, given suitable dimensions, not only a cycle process for the material of the luminous body but also for the material of the power supply line can be set in motion. Such fillings are known per se. In particular, the filling here is a filling for a two-cycle process, as is described in DE-A 103 56 651.1 (as yet unpublished).

Furthermore, the design according to the invention is considerably simpler than previous designs since, in particular for LV applications up to a maximum of 80 V, neither a quartz bar nor a covering coil is required for stabilization purposes, and since, in addition, no problematic contact-making operations are required between an already fully carburized luminous body consisting of TaC and the power supply lines (welding or clamping and/or crimping). When handling an already fully carburized luminous body consisting of TaC, damage often occurs at the ends of the luminous body owing to the brittleness of the material.

The material of the luminous body is preferably TaC. However, carbides of Hf, Nb or Zr are also suitable. In addition, alloys of abovementioned carbides are suitable. Further possibilities are Ta or Ta₂C.

The present invention is particularly suitable for low-volt lamps having a voltage of at most 50 V, since the luminous bodies required for this purpose can be designed to be relatively solid and, for this purpose, the wires preferably have a diameter of between 50 μm and 300 μm, in particular at most 150 μm for general lighting purposes with a maximum power of 100 W. Thick wires up to 300 μm are used in particular in the case of photooptical applications up to a power of 1000 W. Particularly preferably, the invention is used for lamps having a pinch seal at one end, since in this case the luminous body can be kept relatively short, which likewise reduces the susceptibility to breakage. However, the use for lamps having a pinch seal at two ends and lamps for system voltage operation is likewise conceivable.

The actual power supply lines are preferably sealed off in one or two sealing parts of the bulb, the actual power supply line extending at least up to the boundary face of the sealing part, in particular into it. A pinch seal or fuse seal is usually used as the seal.

Preferably, the diameter of the actual power supply line (second section) is at least equal to the diameter of the filament wire from which the first section of the power supply line is also formed; in particular it corresponds to 110 to 140% and a maximum of 160% of this diameter. A starting point for the relationship between the diameter d_{LK} of the wire of the wound luminous body and the diameter d_{eS} of the wire of the actual power supply line (eS) in the colder region of the power supply line is that the ratio should not deviate from the root of the reciprocal of the ratio of the thermal conductivities λ at a mean temperature between the luminous body (LK) and the pinch-seal edge by more than a factor of 3, i.e. is between one third and three times the value of the ratios of the diameters d_{LK}/d_{eS}:

$$\frac{1}{3} \cdot \sqrt{\frac{{λ}_{e S}}{{λ}_{LK}}} \leq \frac{{ⅆ}_{LK}}{{ⅆ}_{e S}} \leq 3 \cdot \sqrt{\frac{{λ}_{e S}}{{λ}_{LK}}}$$

### BRIEF DESCRIPTION OF THE DRAWINGS

The invention will be explained in more detail below with reference to a plurality of exemplary embodiments. In the drawings:

FIG. 1 shows an incandescent lamp having a carbide luminous body in accordance with a first exemplary embodiment;

FIG. 2 shows an incandescent lamp having a carbide luminous body in accordance with a second exemplary embodiment;

FIG. 3 shows an incandescent lamp having a carbide luminous body in accordance with the prior art, and

FIG. 4 shows a detail of the transition between the first and second section of the power supply line.

### PREFERRED EMBODIMENT OF THE INVENTION

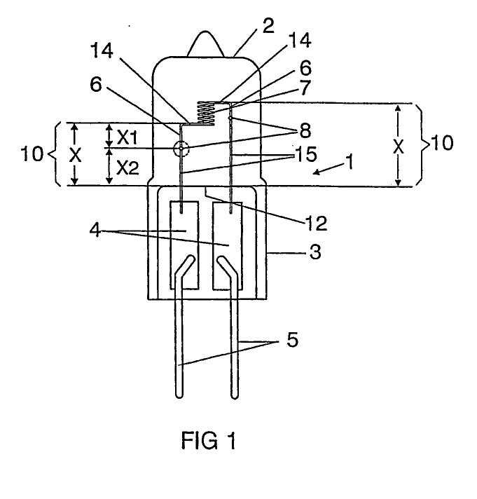

FIG. 1 shows an incandescent lamp 1 having a pinch seal at one end and having a bulb consisting of quartz glass 2, a pinch seal 3, and inner power supply lines 10, which connect foils 4 in the pinch seal 3 to a luminous body 7. The luminous body 7 is a singly wound, axially arranged wire consisting of TaC, whose ends 14 are unwound and protrude transversely with respect to the lamp axis. The outer feed lines 5 are attached on the outside to the foils 4. The inner diameter of the bulb is 5 mm. The unwound ends 14 are then bent back parallel to the lamp axis and form the first section 6 of the entire power supply line 10 there (typical are 20% content X1 of the entire length of the power supply line 10) and form short attachments for the second section 15, often referred to as the actual power supply line (typical are 80% of the length X2 of the second section 15 at the length X of the entire power supply line 10). This second section 15 consists of rhenium and is welded to the first section 6 of the power supply line via a welded joint 8.

The luminous body 7, which is wound from a tantalum wire having a diameter of d_{LK}=0.125 mm, is connected to the actual power supply line 15 consisting of a rhenium wire having a diameter of d_{eS}=0.155 mm, see in this regard also FIG. 4. The rhenium wire of the second section 15 has a larger diameter than the wire of the first section 6 in order to compensate for the electrical conductivity, which is approximately 35% less, and the thermal conductivity λ, which is approximately 15% less, of the rhenium, in each case compared with the tantalum. Of the entire length X of a power supply line 10, calculated from the pinch-seal edge 12 to the end 14 of the filament of the luminous body 7, the first 80% (“colder part”, formed by the actual power supply line 15) consist of rhenium, and the last 20% (“hotter part”, formed by the first section 6) directly on the luminous body consist of tantalum or of tantalum carbide after carburization.

The design described here can also be transferred to lamps having luminous bodies of other metal carbides, for example hafnium carbide, zirconium carbide, niobium carbide.

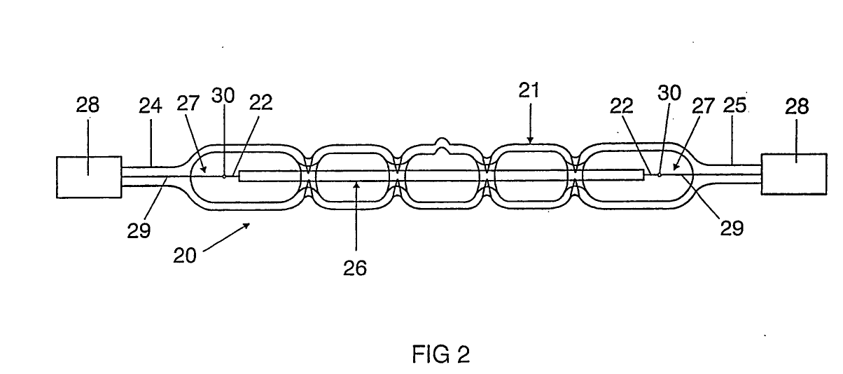

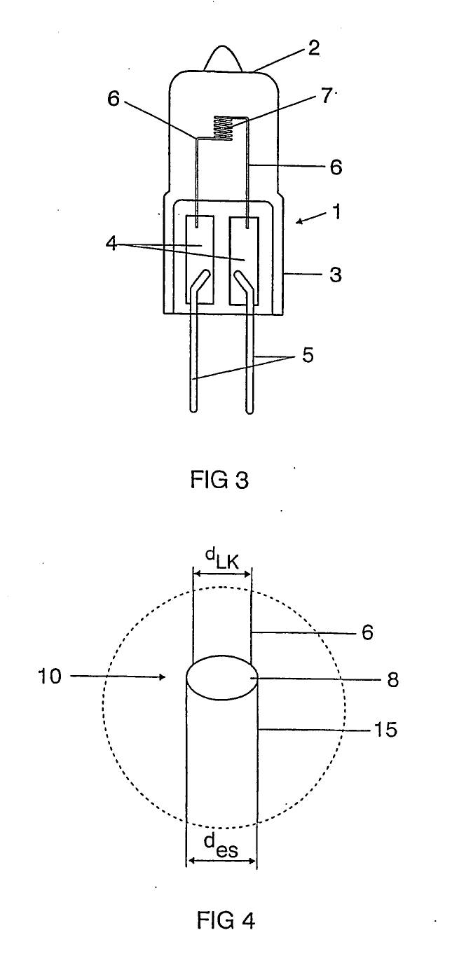

FIG. 2 shows an incandescent lamp 20 having a pinch seal at two ends, also known as a double-ended lamp, having a bulb consisting of quartz glass 21, two pinch seals 24 and 25 and feed lines 27, which are connected to a luminous body 26. The luminous body 26 is wound singly and consists of TaC. The first sections 22 of the power supply lines 27 are formed directly from the unwound end of the luminous body and connected to two sections, the actual power supply lines 29 consisting of osmium, via welded joints 30. The second sections 15 each end in base parts 28, as is known per se, which rest on the pinch seal 24, 25. The inner diameter of the bulb is 15 mm. The luminous body is centered in the bulb by means of holding rings and also by means of glass fingers, both of which are known per se. In the latter case, it is advantageous to produce that region of the luminous body which is surrounded by a glass finger as an interruption of another material such as Re, Ru or Os or to provide this region with a corresponding covering.

In general, the lamp preferably uses a luminous body consisting of tantalum carbide, which preferably comprises a singly wound wire.

The bulb is manufactured from quartz glass or hard glass with a bulb diameter of between 5 mm and 35 mm, preferably between 8 mm and 15 mm.

The filling is primarily inert gas, in particular noble gas such as Ar, Kr or Xe, possibly with the admixture of small quantities (up to 15 mol %) of nitrogen. Added to this are a hydrocarbon, hydrogen and a halogen additive.

Zirconium carbide, hafnium carbide or an alloy of various carbides is also suitable as the luminous body material, which is preferably a wound wire, as described, for example in U.S. Pat. No. 3,405,328.

One alternative is a luminous body which comprises a support material such as, for example, a rhenium wire or else a carbon fiber as the core, this core being coated with tantalum carbide or another metal carbide, see in this regard the application DE-Az 103 56 651.1 (as yet unpublished).

One further possibility consists in first depositing carbon on the luminous body consisting of TaC, for example by means of heating the TaC luminous body in an atmosphere with a high CH₄ concentration. Tantalum carbide is then deposited on this carbon layer. For example, in a CVD process, tantalum can be deposited which is then carburized either by the surrounding carbon and/or from the outside by being heated in an atmosphere containing, for example, CH₄. This has the advantage over the coating of, for example, carbon fibers that the TaC luminous body (based on tantalum) can be produced more easily in any desired shapes.

As a guideline for the filling, a carbon content of from 0.1 to 5 mol %, in particular up to 2 mol %, applies. The hydrogen content is at least the carbon content, preferably two to eight times the carbon content. The halogen content is at most half, in particular one fifth up to one twentieth, in particular one tenth, of the carbon content. Preferably, the halogen content should correspond at most to the hydrogen content, preferably at most to half the hydrogen content. A guideline for the halogen content is from 500 to 5000 ppm. All of these figures relate to a coldfilling pressure of 1 bar. Given changes in the pressure, the individual concentration figures should be recalculated such that the absolute amounts of substance are maintained; for example halve all concentration figures in ppm given twice the pressure.

Specific experiments are presented for a 24 V/100 W lamp. The color temperature is 3800 K. It uses a TaC wire (obtained from carburized tantalum) with a diameter of 125 μm. It is wound singly. The lamp displays a markedly improved breakage response in comparison with an otherwise identical luminous body comprising a wire having a diameter of 190 μm. The breakage tests were carried out with an impact pendulum.

An identical lamp, which, however, uses the conventional rigid electrode holders consisting of molybdenum (Mo), is considerably more susceptible to breakage since, when solid Mo holders are used, the points of the luminous body which are close to the connection point between the Mo electrode and the filament (which initially consists of tantalum) are at such a low temperature that the carburization cannot be concluded, i.e. the brittle subcarbide dominates there. In order to alleviate this problem, additional complexity is involved. For example, the ends of the luminous body which consists of, for example, Ta, Hf, Nb, Zr or alloys of these metals prior to carburization, can be protected from the carburization by a coating.

If, alternatively, electrode holders, which are manufactured from Mo or W, are designed to be so thin that their thermal conductance is so low that the Ta filament is also completely carburized close to the joints, the Mo electrode, which is completely carburized owing to its small diameter, now itself forms a weak point. In order to solve this problem, the electrodes themselves need to be coated with a layer which suppresses or severely delays carburization. For example, the electrodes can be coated with a layer of the above-mentioned metals rhenium, osmium, ruthenium or iridium. Alternatives are the coatings of electrodes with, for example, hafnium boride, zirconium boride and niobium boride. Since, for example, Mo boride is more stable than Mo carbide, the electrodes can be passivated by boriding from the outside. One further possibility consists in coating the Mo or W electrodes with nitrides such as hafnium nitride, zirconium nitride, niobium nitride; these compounds are slowly converted into carbides during carburization, but the time required for this is sufficient, given a sufficiently thick layer thickness, for withstanding the carburization process.

The luminous bodies equipped with the actual power supply line are particularly well suited for transport of the lamp under conventional conditions. In other designs, the luminous body is so sensitive to breakage that special measures would need to be taken for the transport of the lamp.

The length of the entire power supply lines, i.e. the distance between the luminous body and the pinch-seal edge, is insignificant since the problem of possibly incomplete conversion of Ta to TaC is achieved in two stages: the lower section of the power supply line consists of a different material, and the first section is so short that the material Ta is converted reliably into TaC there. The maximum length in the bulb can therefore easily exceed, in particular, 25 mm and be up to 50 or else 75 mm.

For a lamp having a bulb diameter of 10 mm and a luminous body consisting of TaC, a very specific filling consists of the following components: 1 bar (coldfilling pressure) Kr+1% C₂H₄+1% H₂+0.05% CH₂Br₂. The concentration figures are in mol %.

1. An incandescent lamp having a carbide-containing luminous body (7) and having power supply lines (10), which hold the luminous body (7), the luminous body being introduced in a vacuum-tight manner together with a filling in a bulb (2), the luminous body having a metal carbide whose melting point is above that of tungsten, characterized in that a first section (6) of at least one power supply line (10) is produced integrally with the luminous body (7) from a wire, while a second section (15), which is remote from the base, of this power supply line is attached to the first section (6), in particular by means of a welded joint (8), and consists of a high-melting, hard material which does not form any carbides, and which, in addition, has an electrical conductivity and thermal conductivity of the same order of magnitude or less as the material of the luminous body.

2. The incandescent lamp as claimed in claim 1, characterized in that the luminous body (7) consists of tantalum carbide at least at its surface, and in particular is a singly wound wire, whose ends (14) are unwound.

3. The incandescent lamp as claimed in claim 1, characterized in that the bulb (2) consists of quartz glass or hard glass having a bulb diameter of between 5 mm and 35 mm, preferably between 8 mm and 15 mm.

4. The incandescent lamp as claimed in claim 1, characterized in that the filling contains inert gas, in particular noble gas, possibly with an admixture of small quantities of nitrogen, and at least one hydrocarbon, hydrogen and at least one halogen additive.

5. The incandescent lamp as claimed in claim 1, characterized in that the luminous body (7) is a singly wound wire, preferably having a diameter of from 50 to 300 μm, in particular up to 150 μm.

6. The incandescent lamp as claimed in claim 1, characterized in that the length of the second section (15) of the power supply line is selected such that it extends up to a point which is so close to the luminous body that the temperature of the first section (6) of the power supply line including the region of the welded joint (8) is at least 2000° C. or above.

7. The incandescent lamp as claimed in claim 1, characterized in that one of the metals rhenium or osmium or ruthenium or iridium or an alloy thereof is used as the material of the second section (15) of the power supply line.

8. The incandescent lamp as claimed in claim 1, characterized in that the power supply lines (10) are sealed off in one or two sealing parts (3) of the bulb, the actual power supply line (15) extending at least up to the boundary face (12) of the sealing part.

9. The incandescent lamp as claimed in claim 1, characterized in that the diameter d_{LK} of the wire of the wound luminous body and the diameter d_{eS} of the wire of the actual power supply line (15) do not deviate from the root of the reciprocal of the ratio of the thermal conductivities λ at a mean temperature between the luminous body (7) and the pinch-seal edge (12) by more than a factor of 3, i.e. are between one third and three times the value of the ratios of the diameters:
$$\frac{1}{3} \cdot \sqrt{\frac{{λ}_{e S}}{{λ}_{LK}}} \leq \frac{{ⅆ}_{LK}}{{ⅆ}_{e S}} \leq 3 \cdot \sqrt{\frac{{λ}_{e S}}{{λ}_{LK}}}$$

10. The incandescent lamp as claimed in claim 9, characterized in that the diameter of the second section (15) of the power supply line (actual power supply line) corresponds at least to the diameter of the first section (6), preferably 110 to 140%, and a maximum of 160% of the diameter.

11. The incandescent lamp as claimed in claim 1, characterized in that a further, carbide-forming metal, such as molybdenum or tungsten, for example, is used as the material of the second section (15) of the power supply line and is coated on the surface with rhenium or osmium or ruthenium or iridium.

12. The incandescent lamp as claimed in claim 1, characterized in that a further, carbide-forming metal, such as molybdenum or tungsten, for example, is used as the material of the second section (15) of the power supply line and is coated on the surface with borides, such as hafnium boride or niobium boride or zirconium boride, for example, or nitrides such as hafnium nitride, niobium nitride or zirconium nitride.

13. The incandescent lamp as claimed in claim 1, characterized in that a further, carbide-forming metal, such as molybdenum or tungsten, for example, is used as the material of the second section (15) of the power supply line, but is passivated at the surface, for example by boriding.
